(19) United States
(12) Patent Application Publication
(10) Pub. No.: US 2026/0204235 A1
(43) Pub. Date: Jul. 16, 2026

(54) DRIVING DEVICE AND OPERATING METHOD THEREOF

(71) Applicant: HIMAX TECHNOLOGIES LIMITED, Tainan City (TW)

(72) Inventor: Kuang Jung Hsu, Tainan City (TW)

(73) Assignee: HIMAX TECHNOLOGIES LIMITED, Tainan City (TW)

(21) Appl. No.: 19/019,542

(22) Filed: Jan. 14, 2025

(51) Int. Cl. G09G 3/34

(52) U.S. Cl. CPC G09G 3/344; G09G 2310/0275; G09G 2310/08; G09G 2380/04

(57) ABSTRACT

A driving device and the operating method thereof are disclosed. The driving device is adapted to drive an electronic paper display device. The driving device comprises a source driver and a timing controller. The source driver is coupled to the electronic paper display device, and configured to drive the electronic paper display device according to a source controlling signal. The timing controller is coupled to the source driver, and configured to receive input frame data, and to generate the source controlling signal according to the input frame data and lookup table information. The timing controller is configured to generate a source clock signal of the source controlling signal at a constant voltage level according to the lookup table information and the input frame data.

### BACKGROUND

### Technical Field

This disclosure relates to a driving device, and in particular to a driving device that is adapted to driving an electronic paper display device and an operating method thereof.

### Description of Related Art

Retailers may utilize an electronic shelf label (ESL) system for providing product information. Generally, the ESL system may display the current price of the product by an electronic paper display device. When the price is changed, the electronic paper display device is driven by a driving device to refresh the current display screen.

In a process of refreshing the current display screen, the driving device drives the electronic paper display device to display at least one single color (e.g., black and white) for resetting the current display screen. Then, the driving device drives the electronic paper display device to display the updated display screen.

However, for driving the electronic paper display device, the current driving device generates a source clock signal with multiple pulses in the whole process, so as to cause the power consumption.

### SUMMARY

Embodiments of the disclosure provide a driving device, adapted to drive an electronic paper display device, and capable of reducing the power consumption.

The driving device of the present disclosure is adapted to drive an electronic paper display device. The driving device comprises a source driver and a timing controller. The source driver is coupled to the electronic paper display device, and configured to drive the electronic paper display device according to a source controlling signal. The timing controller is coupled to the source driver, and configured to receive input frame data, and to generate the source controlling signal according to the input frame data and lookup table information. The timing controller is configured to generate a source clock signal of the source controlling signal at a constant voltage level according to the lookup table information and the input frame data.

The operating method of the present disclosure adapted to operate a driving device to drive an electronic paper display device. The driving method comprises: receiving, by a timing controller, input frame data; generating, by the timing controller, a source controlling signal according to the input frame data and lookup table information, comprising: generating, by the timing controller, a source clock signal of the source controlling signal at a constant voltage level, according to the lookup table information; and driving, by a source driver, the electronic paper display device according to the source controlling signal.

Based on the above, the driving device and the operating method may effectively reduce power consumption

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate example embodiments of the disclosure and, together with the description, serve to explain the principles of the disclosure.

FIG. 1 is a circuit block diagram of a driving device according to an embodiment of the disclosure.

FIG. 2 is a flow chart of an operating method of the driving device according to an embodiment of the disclosure.

FIG. 3 is a circuit block diagram of a driving device according to another embodiment of the disclosure.

FIG. 4 is a circuit block diagram of an electronic paper display device according to the embodiment of FIG. 3 of the disclosure.

FIGS. 5A and 5B are schematic diagrams of operations of the driving device according to the embodiment of FIG. 3 of the disclosure.

FIG. 6A illustrates operating waveforms of the driving device according to the embodiment of FIG. 3 of the disclosure.

FIG. 6B illustrates operating waveforms of the driving device according to the embodiment of FIG. 3 of the disclosure.

### DESCRIPTION OF THE EMBODIMENTS

Some embodiments of the disclosure will be described in detail below with reference to the accompanying drawings. The reference numerals cited in the following description will be regarded as the same or similar elements when the same reference numeral appears in different drawings. These embodiments are only part of the disclosure and do not disclose all possible implementations of the disclosure. Rather, these embodiments are merely examples within the scope of the disclosure.

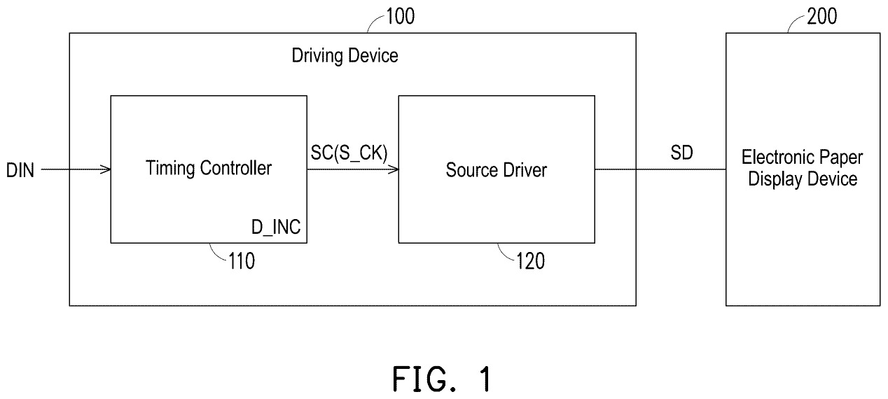

FIG. 1 is a circuit block diagram of a driving device according to an embodiment of the disclosure. Referring to FIG. 1, the driving device 100 may be applied to an electronic shelf label (ESL) system. The ESL system may utilize at least one electronic paper display device 200 to display target information, such as product prices. The driving device 100 is adapted to drive the electronic paper display device 200.

In this embodiment, the electronic paper display device 200 includes multiple pixels to display a display screen. Each one of the pixels includes multiple microcapsule units or microcup units. These units have electrophoretic particles with different colors, such as white electrophoretic particles and black electrophoretic particles.

In this embodiment, the driving device 100 includes a timing controller (also referred as a TCON) 110 and a source driver 120. The timing controller 110 is coupled to the source driver 120. The timing controller 110 is further coupled to an electronic device (not shown) to receive display information (e.g., input frame data DIN). The foresaid electronic device may be a server of the ESL system.

In this embodiment, the source driver 120 is coupled to the electronic paper display device 200. Specifically, the source driver 120 is coupled to the pixels of the electronic paper display device 200 through multiple source lines (not shown in FIG. 1).

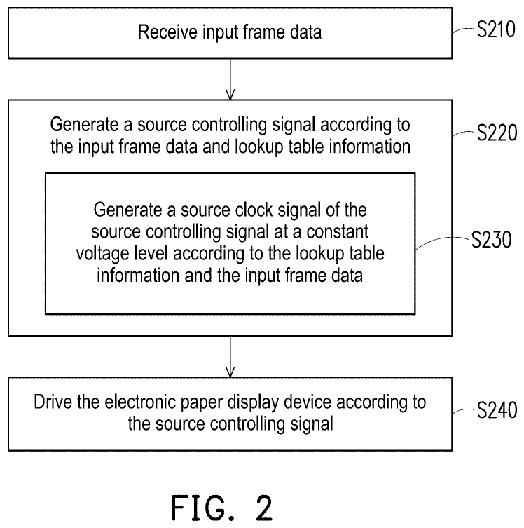

FIG. 2 is a flow chart of an operating method of the driving device according to an embodiment of the disclosure. Referring to FIGS. 1 and 2, the driving device 100 may execute the following steps S210 to S240. The order of these steps S210 to S240 is only for illustration and not limited thereto.

In step S210, the timing controller 110 receives input frame data DIN. The input frame data DIN may be output from the electronic device of the ESL system. The input frame data DIN indicates information of the display screen to be displayed.

In step S220, the timing controller 110 generates a source controlling signal SC according to the input frame data DIN and lookup table information D_INC. The timing controller 110 further outputs the source controlling signal SC to the source driver 120.

In this embodiment, the lookup table information D_INC includes correspondences between input frame data DIN and a voltage level on the corresponding source line. More particularly, the lookup table information D_INC is formed by a plurality of index codes. A voltage value of each index code corresponds to a voltage level used to drive the source line. By looking up the lookup table information D_INC using the input frame data DIN, the timing controller 110 may select one of the index codes as the source data signal SOUT_Data according to the input frame data DIN, so that the corresponding source line may be driven by the voltage level corresponding to the selected index code.

In addition, in the step S230 of the step S220, the timing controller 110 generates a source clock signal S_CK at a constant voltage value, according to the lookup table information D_INC. In this embodiment, the source controlling signal SC further includes source data signal (not shown in FIG. 1) for the source driver 120. The source clock signal S_CK is configured to control clock and signal propagations for the source driver 120. The source data signal indicates a voltage value indicative to a display color to be displayed.

In some embodiments, the source clock signal S_CK is maintained at the constant voltage level after the timing controller 110 receives a plurality of index codes of the lookup table information with a same voltage value. In some scenarios, the electronic paper display device 200 may be used to display dynamic images. The index codes with different voltage values may be provided to the timing controller 110, so that the timing controller 110 may output the source data signal voltage value

In some scenarios, the electronic paper display device 200 may be used to display a static image, and it is not necessary to update the displayed image frequently. To this end, the index codes with the same voltage value may be provided to the timing controller 110. After the timing controller 110 receives the index codes that all have the same voltage value, the timing controller 110 may be configured to pull the source clock signal S_CK to the constant voltage level to reduce signal toggling. In some embodiments, the constant voltage level may be a reference ground voltage level to further reduce static power.

In step S240, the source driver 120 drives the electronic paper display device 200 according to the source controlling signal SC. Specifically, the source driver 120 outputs data driving signals (not shown in FIG. 1) to the pixels according to the source clock signal S_CK and the corresponding source data signal, to drive the electronic paper display device 200 for display.

In this embodiment, since the same voltage value is desired to be applied to all pixels, the timing controller 110 maintains the source clock signal S_CK at the constant voltage value after determining that all index codes are the same. Thereby, during such time period (either a disturbing stage or a driving stage), the timing controller 110 stops oscillating the source clock signal S_CK, thereby reducing power consumption of the driving device 100.

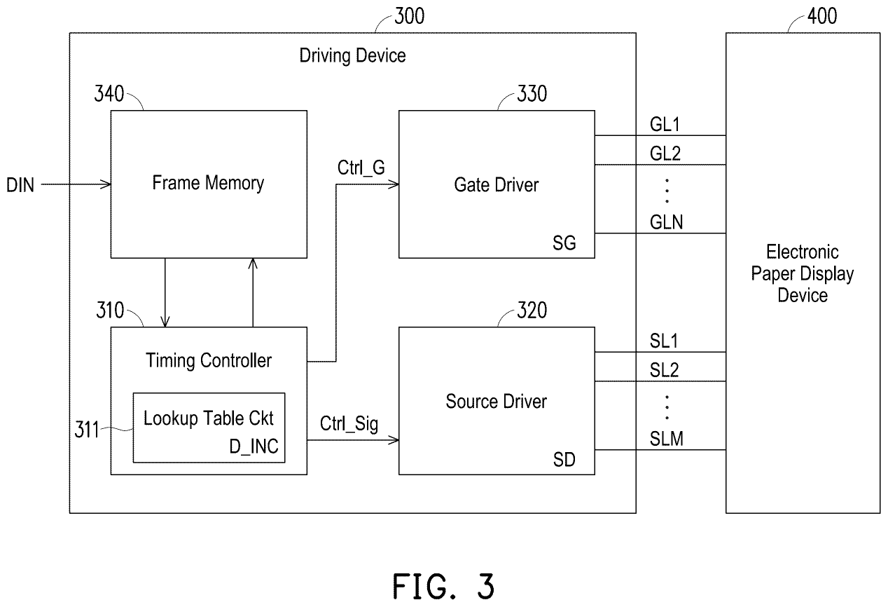

FIG. 3 is a circuit block diagram of a driving device according to another embodiment of the disclosure. Referring to FIG. 3, the driving device 300 is coupled to the electronic paper display device 400. The driving device 300 includes a timing controller 310, a source driver 320, a gate driver 330 and a frame memory 340. The timing controller 310 and the source driver 320 may be described with reference to and by analogy with the driving device 100.

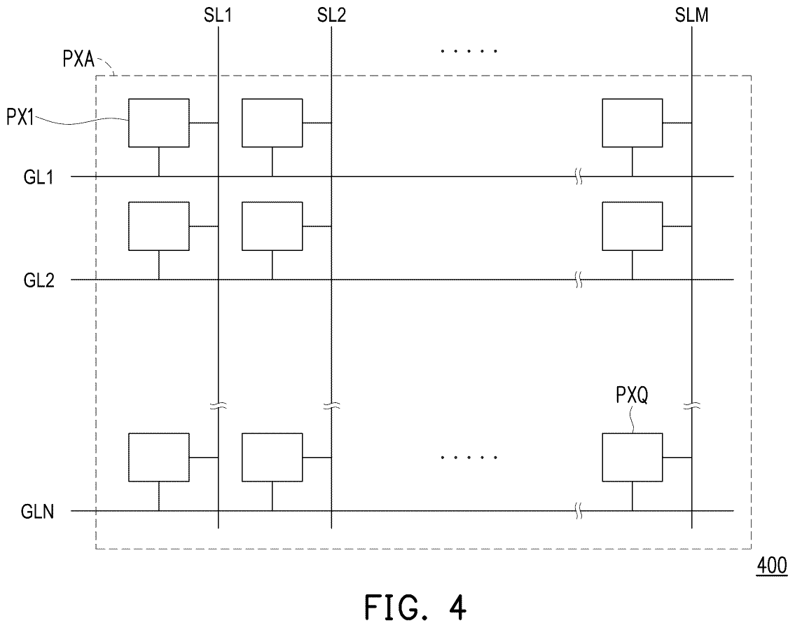

FIG. 4 is a circuit block diagram of an electronic paper display device according to the embodiment of FIG. 3 of the disclosure. Referring to FIG. 3 and FIG. 4, the electronic paper display device 400 includes multiple pixels PX1 to PXQ, multiple gate lines GL1 to GLN, and multiple source lines SL1 to SLM. Q, N, M are respectively positive integer. The pixels PX1 to PXQ are arranged in an array PXA, and have the same circuit architecture. The pixels PX1 to PXQ may be described with reference to and by analogy with the pixels of the electronic paper display device 200.

In this embodiment, the frame memory 330 is coupled to an electronic device (e.g., a server) of the ESL system. The frame memory 330 is configured to receive input frame data DIN from such electronic device, and to temporarily stores the received input frame data DIN. The frame memory 330 is further coupled to the timing controller 310, such that the timing controller 310 accesses data (e.g., the input frame data DIN) stored in the frame memory 340. The frame memory 330 may be, for example, a dynamic random access memory (DRAM), a flash memory, or a non-volatile random access memory (NVRAM), which is not limited in the disclosure.

In this embodiment, the source driver 320 is coupled to the timing controller 310. The source driver 320 is further coupled to the pixels PX1 to PXQ through the source lines SL1 to SLM. The source driver 320 is configured to receive the source controlling signal Ctrl_Sig (i.e., the source controlling signal SC in FIG. 1) output from the timing controller 310. The source driver 320 is configured to output data driving signals SD to the pixels PX1 to PXQ through the source lines SL1 to SLM according to the source controlling signal Ctrl_Sig.

In this embodiment, the gate driver 330 is coupled to the timing controller 310. The gate driver 330 is coupled to the pixels PX1 to PXQ through the gate lines GL1 to GLN. The gate driver 330 is configured to receive a gate controlling signal Ctrl_G output from the timing controller 310. The gate driver 330 is configured to output gate driving signals SG to the pixels PX1 to PXQ through the gate lines GLI to GLN according to gate controlling signal Ctrl_G. As such, the pixels PX1 to PXQ are driven to display the corresponding colors according to the data driving signals SD and the gate controlling signal Ctrl_G.

In the embodiment of FIG. 3, the timing controller 310 includes a lookup table circuit 311. The lookup table circuit 311 is configured to access the input frame data DIN from the frame memory 340. The lookup table circuit 311 is configured to set the lookup table information D_INC according to the input frame data DIN and the index codes. The lookup table circuit 311 may be, for example, implemented by a circuit including a selector, a compactor and a switch, or by a module to implement algorithms, programs, and data related to functions of setting the lookup table information D_INC according to the input frame data DIN and the index codes.

In this embodiment, the driving device 300 may operate in one disturbing stage and in one driving stage, for driving the electronic paper display device 400 to display a target display screen. The disturbing stage and the driving stage are in the same frame.

Specifically, in the disturbing stage, the driving device 300 actives the electrophoretic particles of the pixels PX1 to PXQ at least once, according to the data driving signals SD and the gate controlling signal Ctrl_G. These electrophoretic particles are mixed together, such that the current display screen is recovered to show one single color (i.e., black). After showing the black screen, these electrophoretic particles may be mixed again, such that the current display screen is recovered to show another single color (i.e., white).

Continuously, in the driving stage after the disturbing stage, the driving device 300 drives the electrophoretic particles of the pixels PX1 to PXQ, according to the data driving signals SD and the gate controlling signal Ctrl_G. These electrophoretic particles are located at the corresponding positions, such that the current display screen is updated to show the target display screen.

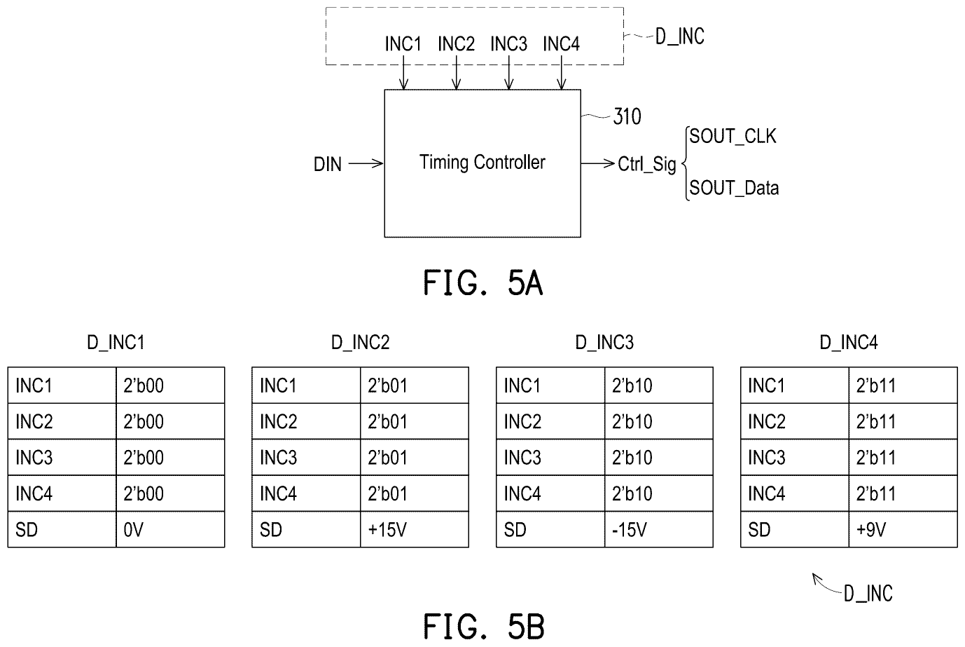

FIGS. 5A and 5B are schematic diagrams of operations of the driving device according to the embodiment of FIG. 3 of the disclosure. Referring to FIG. 3, FIG. 5A, and FIG. 5B, operations of how the driving device 300 generates the source controlling signal Ctrl_Sig may be illustrated. Based on the lookup table information D_INC, the driving device 300 generates a source clock signal SOUT_CLK (i.e., the source clock signal S_CK in FIG. 1) and a source data signal SOUT_Data of the source controlling signal Ctrl_Sig.

In this embodiment, the timing controller 310 receives the input frame data DIN from the frame memory 340. The timing controller 310 sets the lookup table information D_INC by the lookup table circuit 311, according to the input frame data DIN.

Specifically, in response to the received input frame data DIN, the lookup table circuit 311 sets the lookup table information D_INC by selecting one from the index codes INC1 to INC4 as the source data signal SOUT_Data.

As shown in FIG. 5B, the lookup table information D_INC includes correspondences between the index codes INC1 to INC4 and the voltage level of the data driving signal SD. In general, the timing controller 310 is configured to selecting one of index codes INC1-INC4 as the source data signal SOUT_Data. The selected index code may have a voltage value indicative to a desired voltage level for a corresponding source line, so that the source data signal SOUT_Data may be then converted into the driving data signal at the desired voltage level to drive the corresponding source line. In brief, according to the correspondences listed in FIG. 5B, the driving device 300 may be configured to drive the pixels at a proper voltage level according to the input frame data DIN and the index codes INC1-INC4. These correspondences may be, for example, represented as multiple sub tables D_INC1 to D_INC4. The quantities of sub tables D_INC1 to D_INC4 and the index codes INC1 to INC4 are only examples since the index codes INC1-INC4 may be represented by different bit numbers rather than two bits.

In detail, the lookup table information D_INC includes a plurality of index codes INC1 to INC4. Each one of the index codes INC1 to INC4 may be represented by a binary number, such as “00”, “01”, “10” or “11.” In this embodiment, the binary number of each of the index codes INC1 to INC4 may correspond to one of a plurality of voltage values for showing different display colors. In FIG. 5B, the sub tables D_INC1-D_INC4 listed four cases which the index codes INC1-INC4 are the same, and the corresponding voltage level of the data driving signal SD.

In the sub table D_INC1, when all of the index codes INC1-INC4 are represented by “00,” the source data signal SOUT_Data is corresponding set as the same voltage value, and the source data signal SOUT_Data may be controlled by the source driver 320 at a corresponding voltage level of 0V. The source data signal SOUT_Data with the voltage level of OV may be used to drive the pixels for displaying a first color (e.g., an original color inputted in last frame). In the sub table D_INC2, when all of the index codes INC1-INC4 are represented by “01,” the source data signal SOUT_Data is corresponding set as the same voltage value, and the source data signal SOUT_Data may be controlled by the source driver 320 at a corresponding voltage level of +15V. The source data signal SOUT_Data with the voltage level of +15V may be used to drive the pixels for displaying a second color (e.g., a white color). In the sub table D_INC3, when all of the index codes INC1-INC4 are represented by “10,” the source data signal SOUT_Data is corresponding set as the same voltage value, and the source data signal SOUT_Data may be controlled by the source driver 320 at a corresponding voltage level of −15V. The source data signal SOUT_Data with the voltage level of −15V may be used to drive the pixels for displaying a third color (e.g., a black color). In the sub table D_INC4, when all of the index codes INC1-INC4 are represented by “11,” the source data signal SOUT_Data is corresponding set as the same voltage value, and the source data signal SOUT_Data may be controlled by the source driver 320 at a corresponding voltage level of +9V. The source data signal SOUT_Data with the voltage level of +9V may be used to drive the pixels for displaying a fourth color (e.g., a red color).

In the embodiments as listed in FIG. 5B, since the timing controller 310 is configured to select one from the index codes INC1-INC4 as the source data signal SOUT_Data according to the input frame data DIN, when all of the index codes INC1-INC4 are the same, the timing controller 310 is configured to output the source data SOUT_Data with the same voltage value regardless of how the input frame data DIN changes. In this way, it becomes unnecessary for the source driver 320 to update the source data signal SOUT_Data by the trigger of the source clock signal SOUT_CLK, so that the source clock signal SOUT_CLK may be kept at a constant voltage level once the timing controller 310 determines that all of the received index codes INC1-INC4 are the same.

In some embodiments, the timing controller 310 is configured to determine whether all of the received index codes INC1-INC4 are the same in a period for driving a first gate line GL1, and control the source clock signal SOUT_CLK at the constant voltage level in the following periods for driving gate lines GL2-GLN. In other words, the timing controller 310 may be configured to drive the electronic paper display device 400 without the source clock signal SOUT_CLK oscillating after all of the index codes INC1-INC4 are determined to be the same.

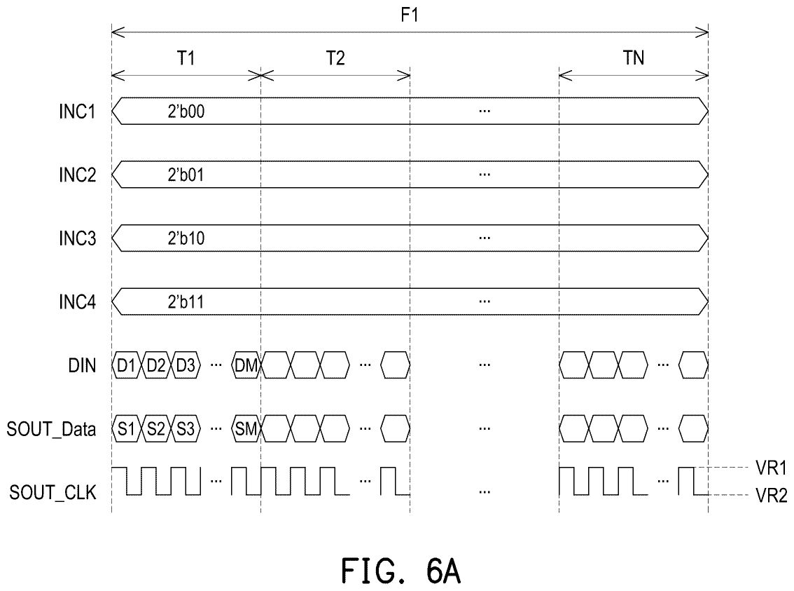

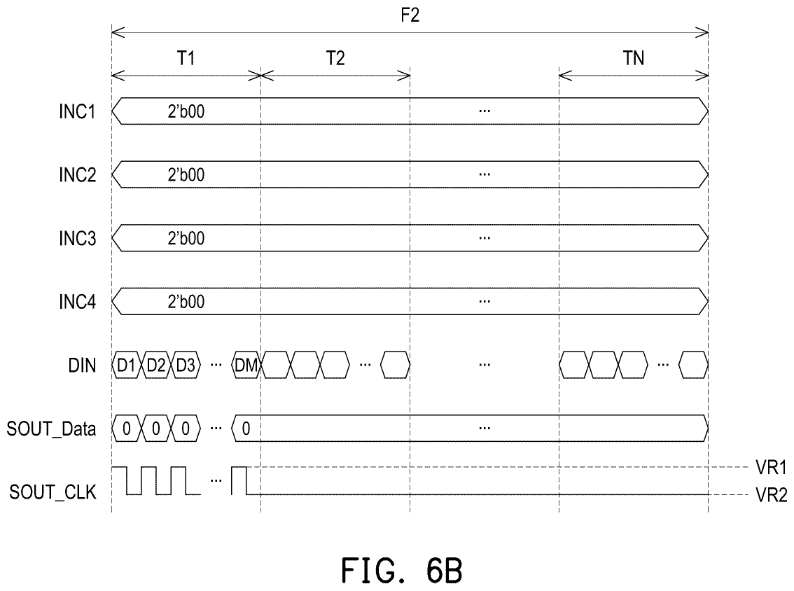

FIG. 6A illustrates operating waveforms of the driving device 300 according to the embodiment of FIG. 3 of the disclosure.

In this embodiment, waveforms within a frame time F1 including periods T1-TN are illustrated in FIG. 6A. Specifically, the electronic paper display device 400 may be driven by the driving device 300 to display a corresponding image in each frame time, meaning that each pixel needs to be driven at least once in each frame time to display the corresponding color. In this embodiment, the frame time F1 is separated into N line times T1-TN, and a gate line is driven in a corresponding line time by the driving device 300. Further, each line time is separated into M time periods, and each of the M pixels on the corresponding gate line is driven in a corresponding time period by the driving device 300.

Specifically, in the line time T1, the input frame data DIN includes display data D1-DM respectively for driving M pixels on the first gate line. The timing controller 310 may be configured to select one of the index codes INC1-INC4 as the source data signal SOUT_Data according to the inputted input frame data DIN. In this embodiment, the source data signal SOUT_Data in the first line time T1 includes voltage values S1-SM for respectively driving the M source lines. In the subsequent line times T2-TN, the same operations are repeated for driving remaining gate lines.

In this embodiment, the timing controller 310 may be configured to receive the index codes INC 1-INC4 with the voltage values of 0-3. After the timing controller 310 determines that the received index codes INC1-INC4 have inconsistent voltage values, the timing controller 310 may be configured to keep driving the source clock signal oscillating between voltage level VR1 and VR2 in the remaining line times T2-TN of the frame time F1. In this embodiment, the driving device 300 may be configured to drive each pixel in the electronic paper display device 400 to display a corresponding color.

FIG. 6B illustrates operating waveforms of the driving device 300 according to the embodiment of FIG. 3 of the disclosure. In this embodiment, waveforms within a frame time F2 including periods T1-TN are illustrated in FIG. 6B.

In this embodiment, the timing controller 310 may be configured to receive the index codes INC 1-INC4 with the same voltage value of 2′b00. After the timing controller 310 determines that the received index codes INC1-INC4 have the same voltage value in the first line time T1, the timing controller 310 may be configured to stop driving the source clock signal SOUT_CLK in the second line time T2. In this embodiment, the timing controller 310 is configured to maintain the source clock signal SOUT_CLK at the voltage level VR2 in the remaining line times T2-TN of the frame time F2. In this way, signal toggles of the source clock signal SOUT_CLK may be effectively reduced and power consumption of the driving device 300 is reduced. In this embodiment, the voltage level VR2 may be a ground voltage level, so that the source clock signal SOUT_CLK may be maintained at a low voltage level to further reduce a direct current (DC) power consumption.

To sum up, in the driving device and the operating method thereof of the embodiments of the disclosure, by maintaining the source clock signal at the constant voltage value, the timing controller is capable of reducing signal toggling, thereby saving power. As such, without affecting the target display screen, the driving device is capable of achieving the function of recovering the current display screen, and reducing the power consumption.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A driving device, adapted to drive an electronic paper display device, comprising:
a source driver, coupled to the electronic paper display device, and configured to drive the electronic paper display device according to a source controlling signal; and
a timing controller, coupled to the source driver, and configured to receive input frame data, and to generate the source controlling signal according to the input frame data and lookup table information,
wherein the timing controller is configured to generate a source clock signal of the source controlling signal at a constant voltage level according to the lookup table information and the input frame data.

2. The driving device according to claim 1, wherein the timing controller is configured to maintain the source clock signal at the constant voltage level after the timing controller receives a plurality of index codes of the lookup table information with a same voltage value.

3. The driving device according to claim 2, wherein the timing controller is configured to select one of the plurality of index codes as a source data signal of the source controlling signal according to the input frame data.

4. The driving device according to claim 3, wherein the source driver is configured to generate a data driving signal at a voltage level corresponding to a value of the source data signal.

5. The driving device according to claim 4, wherein the source driver is configured to drive a corresponding pixel for displaying a display color corresponding to the voltage level of the data driving signal.

6. The driving device according to claim 2, wherein the timing controller is configured to determine whether to maintain the source clock signal at the constant voltage level in a first line time of each frame period.

7. The driving device according to claim 6, wherein after the timing controller receives the plurality of index codes with the same voltage value in the first line time, the timing controller is configured to maintain the source clock signal at the constant voltage level at a second line time subsequent to the first line time of the same frame period.

8. The driving device according to claim 7, wherein the driving device is configured to drive a first gate line and a second gate line respectively in the first line time and the second line time.

9. The driving device according to claim 2, wherein the source clock signal is pulled to a reference ground voltage level after the timing controller determines that all of the received index codes are the same.

10. An operating method of a driving device, wherein the driving device is adapted to drive an electronic paper display device, the driving method comprising:
receiving, by a timing controller, input frame data;
generating, by the timing controller, a source controlling signal according to the input frame data and lookup table information, comprising:
generating, by the timing controller, a source clock signal of the source controlling signal at a constant voltage level, according to the lookup table information; and
driving, by a source driver, the electronic paper display device according to the source controlling signal.

11. The operating method according to claim 10, wherein the source clock signal is maintained, by the timing controller, at the constant voltage level after a plurality of index codes of the lookup table information with a same voltage value are received.

12. The operating method according to claim 11, wherein one of the plurality of index codes is selected, by the timing controller, as a source data signal of the source controlling signal according to the input frame data.

13. The operating method according to claim 12, wherein a data driving signal is generated, by the source driver, at a voltage level corresponding to a value of the source data signal.

14. The operating method according to claim 13, wherein a corresponding pixel is driven, by the source driver, for displaying a display color corresponding to the voltage level of the data driving signal.

15. The operating method according to claim 11, wherein whether to maintain the source clock signal at the constant voltage level is determined, by the timing controller, in a first line time of each frame period.

16. The operating method according to claim 15, wherein after the plurality of index codes with the same are received by the timing controller in the first line time, the source clock signal is maintained, by the timing controller, at the constant voltage level at a second line time subsequent to the first line time of the same frame period.

17. The operating method according to claim 16, wherein a first gate line and a gate line are driven, by the driving device, respectively in the first line time and the second line time.

18. The operating method according to claim 11, wherein the source clock signal is pulled to a reference ground voltage level after the timing controller determines that all of the received index codes are the same.
